(19) United States
(12) Patent Application Publication
(10) Pub. No.: US 2006/0080678 A1
(43) Pub. Date: Apr. 13, 2006

(54) Task distribution method for protecting servers and tasks in a distributed system

(76) Inventors: Mark W. Bailey, Clinton, NY (US); Kevin A. Kwiat, Whitesboro, NY (US)

Correspondence Address: Joseph A. Mancini;AFRL/IFOJ, 26 Electronic Parkway, Rome, NY, 13441-4514, US

(21) Appl. No.: 10/935,331

(22) Filed: Sep. 7, 2004

(51) Int. Cl. G06F 9/46

(52) U.S. Cl. 719/325

(57) ABSTRACT

Method for securing tasks and servers in a distributed system from outside attack. Tasks are protected from modification and faulty execution using a combination of redundancy and distribution of data. A stripe virtual machine process control the execution of remote tasks at each server. Stripes are executed redundantly on multiple servers and concurrently on each server. A poller determines the majority machine state among the servers. Attacks are annulled by voting down the attacked server's state and restoring it to the majority state.

### STATEMENT OF GOVERNMENT INTEREST

The invention described herein may be manufactured and used by or for the Government of the United States for governmental purposes without the payment of any royalty thereon.

### BACKGROUND OF THE INVENTION

A client/server model of computation, where the client provides a task for the server to perform, is often used when it is more efficient for the client to transmit a task to the server than it would be for the server to transmit task data to the client—due to bandwidth limitations, response time requirements, or security considerations.

Referring to FIG. 1, the architecture of a prior art client/server fault-tolerant distributed system with redundant servers and a poller is depicted. In situations where fault-tolerance is critical, multiple, redundant servers 102 may be used, where each performs the same task and communicates their results to a poller 103. The poller 103 compares the results and masks erroneous server results by communicating only the majority result to the client 101.

Erroneous task results may occur for a variety of reasons, including: interception and modification of a client task en route to a server, or compromise of a server by an outside agent. For such a system to be effective, the client and servers must agree to cooperate. The client must trust that the servers will faithfully perform the client's task and the servers must trust that the client's task will not attack the servers.

Referring to FIG. 2, a prior art storage system using a block-interleaved distributed parity RAID (Level 5) configuration, is shown. RAID (Redundant Array of Independent Disks) storage systems maintain data integrity by using arrays of disks[2]. Although RAID uses an array of physical disks, it presents a single logical storage volume to the machine. The storage system depicted uses an array with N disks, where N=5 104, where each logical storage block is divided into N-1 sub-blocks called stripes 105. Each of these stripes is placed on a distinct disk in the array. The Nth stripe 106 stores the computed parity (bit-wise exclusive OR) of the other N-1 stripes. Thus, RAID employs distribution in its use of multiple physical disks and redundancy in its use of parity. The data redundancy enables recovery from failure of any single disk. When a disk fails, it will contain either a data stripe or a parity stripe for a given logical disk block. A lost parity stripe can be recomputed using the original N-1 data stripes, while a lost data stripe can be recovered by computing the parity of the N-2 data stripes and the parity stripe. Distributing the data across N disks also improves performance of the logical disk since each of the physical disks can be accessed in parallel.

Referring to FIG. 3, it is depicted how task execution is performed in parallel (for redundancy) and each instance being further distributed across all remote servers, wherein the execution of one task instance is distributed across the servers, is depicted. First, the client 107 transmits the task 108 to the set of redundant servers 109, 110, 111, and 112. The servers identically divide the task 108 into subtasks called stripes where each server contains the total task 114 comprised of stripes, and at a given time, a stripe to be executed 113 on that server. The execution of each stripe is assigned to a remote server. The task begins execution on server A 109. When execution of the task reaches the end of the first stripe, the server captures the state of the execution 115. The server then transmits the state of execution to the server B 110, where the state is loaded into the stripe virtual machine and execution picks up where the previous server left off. This process of task execution followed by state capture and execution hand-off continues until the task completes execution on the server D 112. Server D then transmits the results 116 of the task back to the client.

Referring to FIG. 4, now depicting how an intermediary host could compromise a stripe. The distribution of a task across a set of servers does not, in itself, provide any degree of fault tolerance. Without further mechanisms, stripe execution may be corrupted either by a malicious intermediary or a compromised server. As the client transmits the task to each server, an intermediary 117 intercepts and modifies a task en route to a server. In this case, the second server receives the modified task 118. Execution of the task continues correctly until the second server is reached. At this point, the modified task executes for the duration of the stripe. The result of executing the modified task is a corrupt state 119 that is transmitted to the third and fourth servers, finally resulting in an erroneous result 120.

Referring to FIG. 5, depicting an equally disastrous alternative occurring when a server is compromised. In this example, the client successfully transmits tasks to each of the servers, but the second server has already been previously compromised 121. When control of the task execution is passed to the second server, the server either incorrectly executes the task, or simply modifies the task prior to execution. The result is the same: an incorrect final stripe state in the second server 122. This state is then passed through the remaining servers where, again, an erroneous result is produced 123.

### REFERENCES

[1] Michael G. Burke, Jong-Deok Choi, Stephen Fink, David Grove, Michael Hind, Vivek Sarkar, Mauricio J. Serrano, V. C. Sreedhar, Harini Srinivasan, and John Whaley, The jalapefio dynamic optimizing compiler for java, Proceedings of the ACM 1999 conference on Java Grande, ACM Press, 1999, pp. 129-141.
[2] Peter M. Chen, Edward K. Lee, Garth A. Gibson, Randy H. Katz, and David A. Patterson, Raid: high-performance, reliable secondary storage, ACM Computing Surveys 26 (1994), no. 2, 145-185.
[3] Sun Microsystems, The java hotspot virtual machine, vl.4.1, d2, September 2002.
[4] Kevin Scott and Jack Davidson, Safe virtual execution using software dynamic translation, Proceedings of the 18th Annual Computer Security Applications Conference, December 2002, pp. 56-61.

### OBJECTS AND SUMMARY OF THE INVENTION

It is therefore an object of the present invention to provide a methodology for protecting servers in a distributed system by controlling the execution of remote tasks at each server by a stripe virtual machine process.

A further object of the present invention is to provide a method which executes stripes redundantly on multiple servers and concurrently on each server in a distributed system.

Another object of the present invention is to employ a poller to determine the majority virtual machine state among each server in the distributed system.

Still another object of the present invention is to provide a method for annulling the effect an attack on server by voting down the attacked server's state and restoring the attacked server's state to the majority state.

Still yet another object of the present invention is to provide an apparatus capable of implementing computer-readable steps to achieve all aforesaid objects of the present invention.

Briefly stated, the present invention provides a method for protecting servers and tasks in a distributed system, comprising controlling the execution of remote tasks at each server by a stripe virtual machine process; the stripe virtual machine process further comprises executing the stripes within a stripe execution environment and managing the stripe states; executing stripes within the stripe execution environment further comprises starting and stopping the servers, resuming execution of the tasks, and translating between application code and machine code; managing stripe states further comprises enabling the servers to capture the current memory state of a stopped task, transmitting the captured task to other servers through a network adapter and receiving task state updates from other servers. The present invention also comprises executing stripes redundantly on multiple servers and concurrently on each server.

A feature of the present invention for executing stripes redundantly on multiple servers comprises the steps of transmitting each task from client to each server, loading each task onto each server, executing stripe in each server, capturing the virtual machine state in each server, transmitting the virtual machine state from each server to poller, comparing and tallying the results in the poller, determining whether the task is completed, where if the task is completed, then transmitting the final result from the poller to the client, but if it is determined that the task is not completed then the present invention transmits majority state from said poller to the servers, loads the new majority virtual machine state into the servers, and returns to the step of executing stripe in each server.

Another feature of the present invention for executing stripes concurrently on each server comprises the steps of loading a task onto a server, determining whether stripe is completed, where if the stripe is completed, then the present invention captures virtual machine state, transmits the virtual machine state to the poller and determines whether the task is completed, where if the task is completed, then the present invention stops executing stripes concurrently, otherwise, if it is determined that the task is not completed, then the present invention loads a new majority virtual machine state and then determines whether a new stripe is to be executed, where if a new stripe is to be executed, the present invention returns to the step of loading a task onto a server but if the present invention determines that a new stripe is not to be executed, then it returns to the step of loading a new majority virtual machine state, but if it is determined that the stripe is not completed then the present invention fetches and executes an instruction, loads the next server and returns to the step of determining whether the stripe is completed.

Yet another feature of the present invention for annulling an intermediary attack in a distributed system comprises the steps of forwarding the virtual machine state of each of a plurality of servers to a poller, determining a majority state among said plurality of servers, identifying an incorrect modified task in one of the servers where the task has been modified as a result of said intermediary attack, loading the majority state into all servers prior to the execution of the first stripe, restoring to the correct majority state, the state of server which contains the incorrect modified task and repeating the steps of forwarding, determining, identifying, loading and restoring for each round of stripe execution.

Still yet another feature of the present invention for annulling the affect of a compromised server on a task in a distributed system comprises the steps of comparing the stripe state of each of a plurality of servers in a poller, determining a majority state among the plurality of servers and voting down the compromised server's state by the majority state.

To the accomplishment of the foregoing and related ends, the present invention, then, comprises the features hereinafter fully described and particularly pointed out in the claims. The following description and the annexed figures set forth in detail certain illustrative embodiments of the invention. These embodiments are indicative, however, of but a few of the various ways in which the principles of the invention may be employed. Other objects, advantages and novel features of the present invention will become apparent from the following detailed description of the invention when considered in conjunction with the figures.

### BRIEF DESCRIPTION OF THE DRAWINGS

FIG. 1 depicts a prior art fault-tolerant distributed system with redundant servers and a poller.

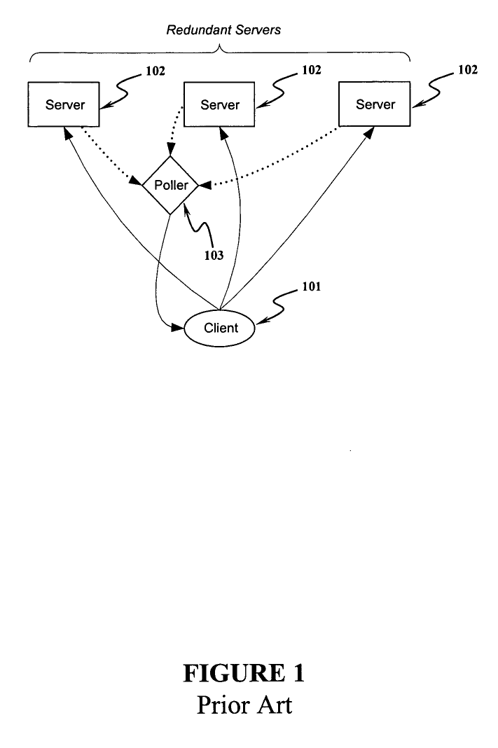

FIG. 2 depicts a prior art block-interleaved distributed parity RAID level 5.

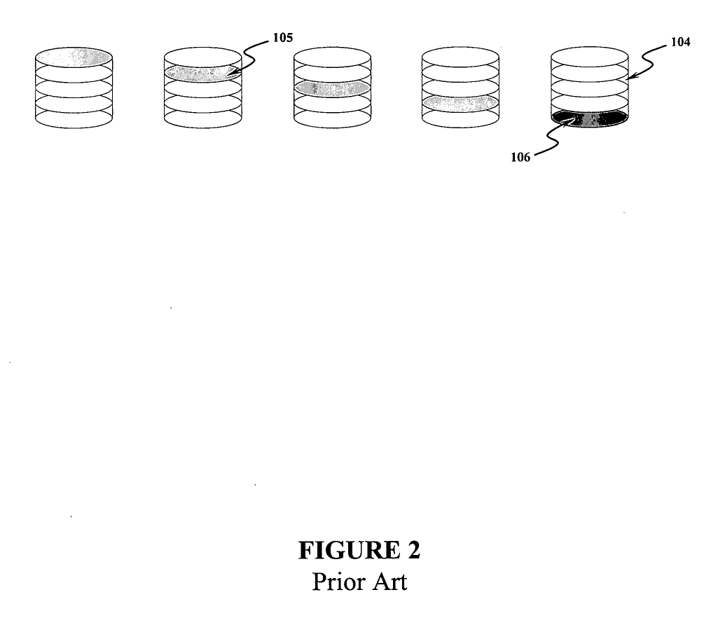

FIG. 3 depicts a distributed task execution across servers.

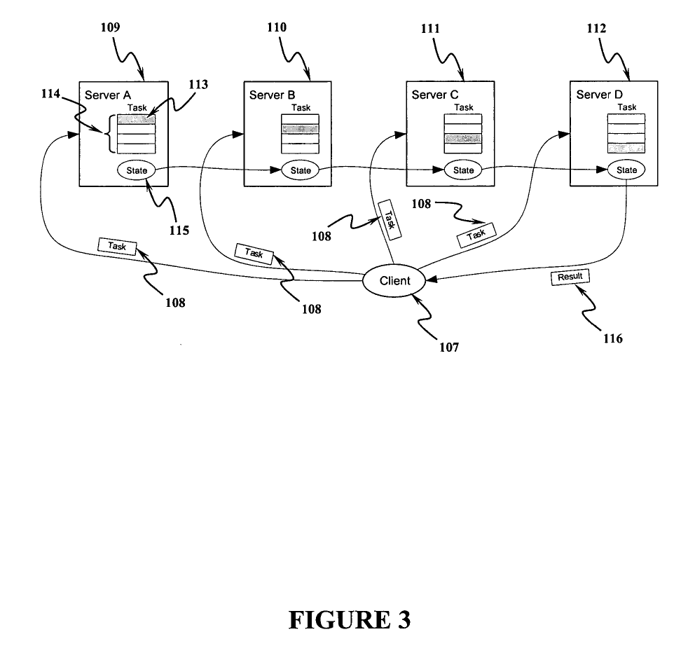

FIG. 4 depicts a intermediary intervention of stripe execution in a distributed task execution.

FIG. 5 depicts a changed result in a distributed task execution.

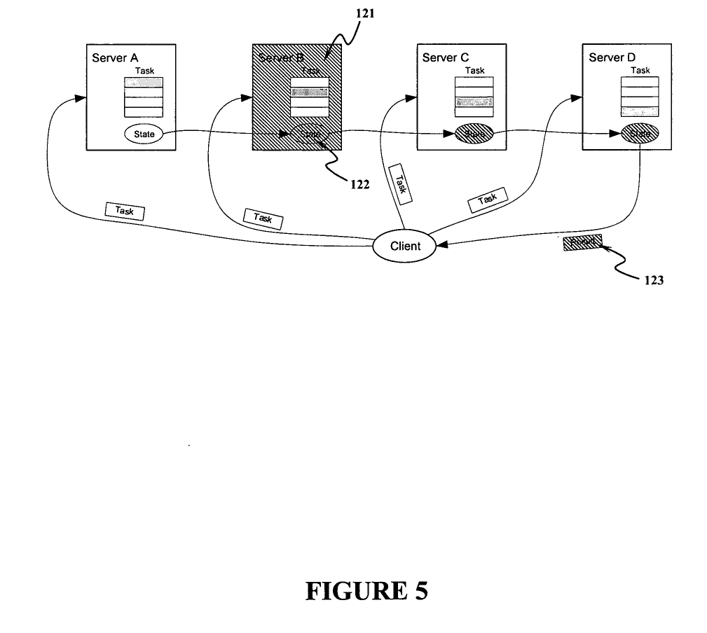

FIG. 6 depicts a server stripe virtual machine of the present invention.

FIG. 7 depicts a redundant stripe execution process of the present invention.

FIG. 8 depicts a concurrent stripe execution process of the present invention.

FIG. 9 depicts how the present invention annuls intermediary attacks.

FIG. 10 depicts how the present invention annuls an attack on a task by a compromised server.

### DETAILED DESCRIPTION OF THE GENERALIZED EMBODIMENT

The present invention increases the security of tasks and servers in the presence of outside attackers. The task is protected from modification and faulty execution in much the same way that data is protected in quality industrial data storage systems. In data storage systems, data integrity is ensured using a combination of redundancy and distribution of data. These techniques can be applied equally well to tasks as to data with similar advantages.

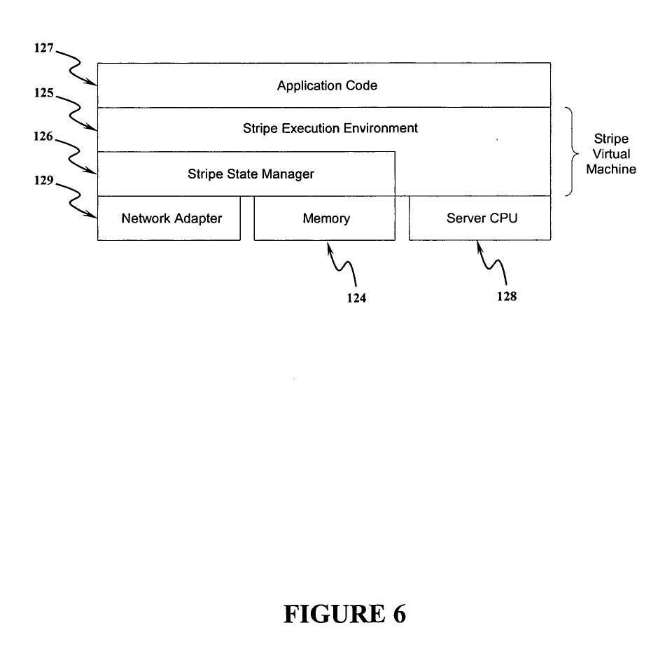

Referring to FIG. 6, the present invention couples RAID striping with a redundant, distributed system to yield a powerful mechanism for protecting the integrity of remote tasks. Execution of remote tasks is controlled at each server by the stripe virtual machine. The stripe virtual machine provides an environment in which tasks execute and further provides mechanisms for servers to start, stop, and resume execution of each task. This is achieved by two components: the stripe execution environment 125, and the stripe state manager 126. The stripe execution environment provides the server start, stop, and resume mechanisms, and any translation (through interpretation) between the application code 127 and the native machine code. The stripe state manager enables the server CPU 128 to capture the current memory 124 state of a stopped task, transmit the captured task to other servers using the network adapter 129, and receive task state updates from other servers. Such an environment can be constructed using a Java virtual machine implementation [1, 3] or a dynamic translation system such as Strata[4]. The invention does not mandate any particular choice of implementation.

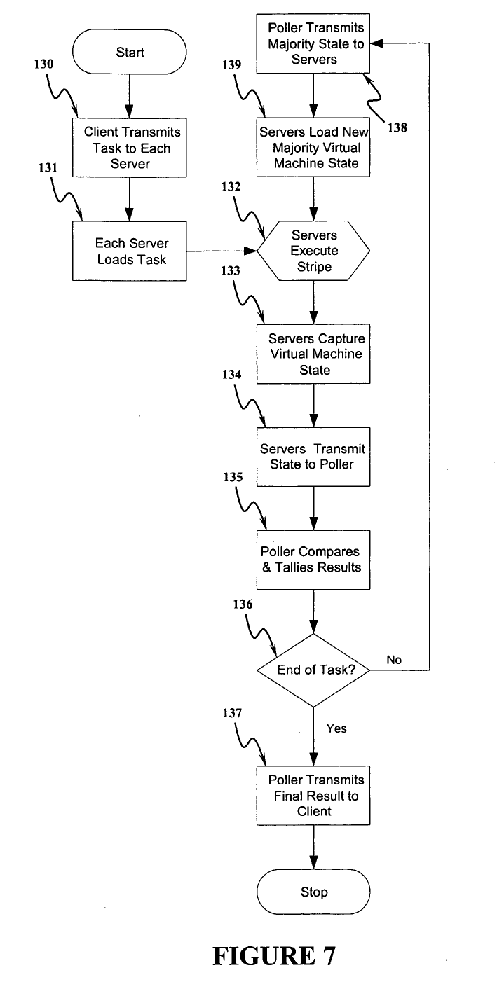

Referring to FIG. 7, a process for redundant stripe execution is depicted. Of importance to the client is the proper execution of its task. Should the client's task be modified by an intermediate server along the way to a server, or the stripe become dispatched to a compromised server, the task might not be performed correctly. The present invention addresses these vulnerabilities by imposing the additional requirement that each stripe be executed on multiple (more than two) servers. This introduces the necessary degree of redundancy to recover from such situations. A client transmits the task 130 to each server whereupon each server loads the task 131. Servers execute the stripe 132 and capture 133 the virtual machine state. Now, upon completion of the execution each stripe, each active server makes available 134 to a poller the stripe's state of execution so it can be compared to and tallied 135 with the results from all other active servers and checks 136 to see if the task is ended. This comparison can be performed by a centralized poller, or by a distributed polling algorithm by broadcasting the states (votes) to all servers. The system determines the initial state of the next stripe by a majority vote of all participating servers. Thus, the degree of integrity of the system is determined by the number of redundant servers. If it is determined that the task is ended, the poller transmits the final result to the client 137 and then stops. If it is determined that the task has not ended, the present invention returns to the steps of having the poller transmit the majority state to the servers 138, servers loading the new majority virtual machine state 139, aforementioned step of servers executing the stripe 132, and so on.

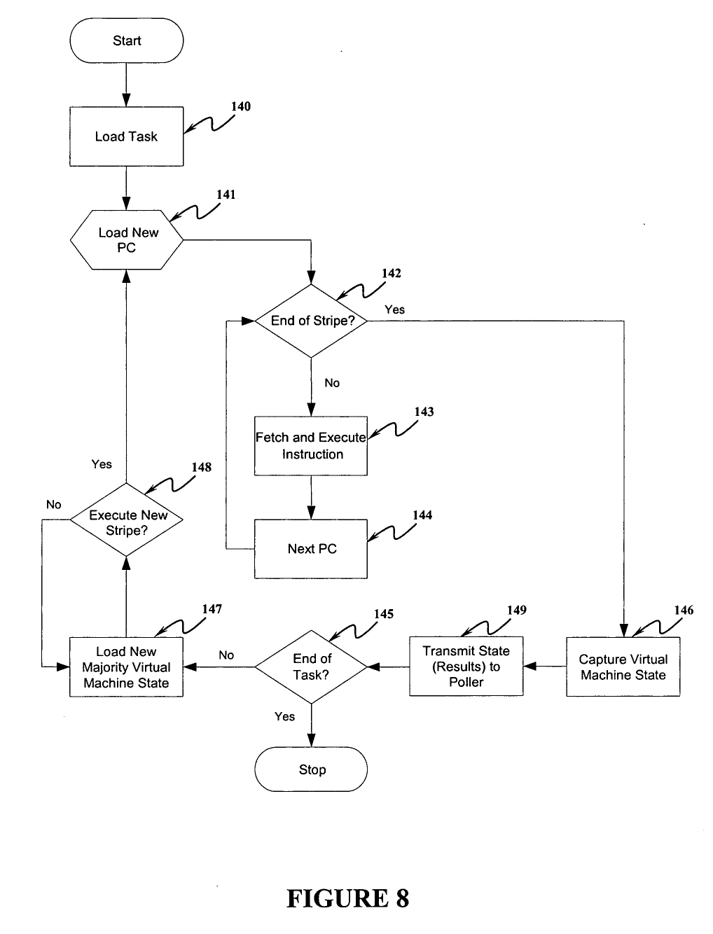

Referring to FIG. 8, the stripe execution process that runs concurrently on each server is depicted. The task is loaded onto the server 140, 141. The invention then checks for completion of the stripe 142. If it is determined that the stripe was not completed, the invention fetches and executes an instruction 143, loads the next server 144 and checks again for the completion of the stripe 142. If it is determined that the stripe was completed, the virtual machine halts execution and captures the virtual machine state 146 of the stripe's execution. The stripe's state is transmitted 149 to the poller (see FIG. 7, 135) to determine the next stripe's beginning execution state. The poller forwards this new state to all participating servers, where it is loaded into the virtual machine. Each stripe is executed 148 on selected servers. Each server loads the stripe into the stripe virtual machine state 147. The stripe virtual machine is initialized and executes the stripe 148. This process repeats until it is determined that the entire client task is completed (see FIG. 7, 136). At that point, the results of the task are voted on and transmitted to the client (see FIG. 7, 137).

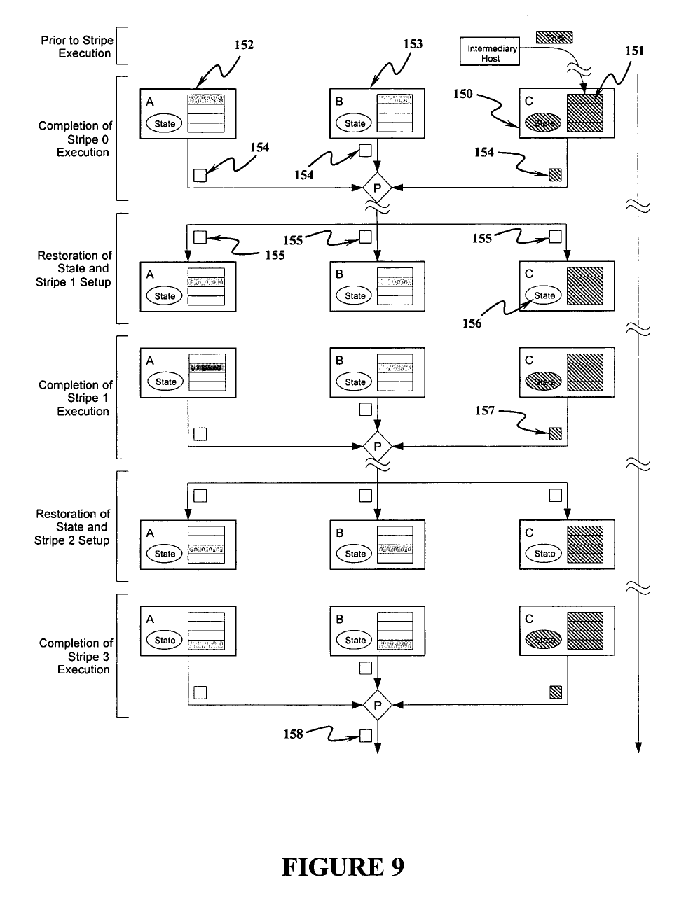

Referring to FIG. 9, the effect of a client task may be altered en route to one of the servers by an intermediary that has access to the network along the transmission path is depicted. In this situation, the intermediary may substitute an alternate task for the client's original task in order to generate faulty results for the client. The alternate task is transmitted to a server that then faithfully executes the alternate task each time a stripe is assigned to that server. The alternate task will then produce a stripe execution state that conflicts with the remaining N-1 servers that are concurrently executing the client's stripe. Upon comparison by the poller, the alternate task's stripe state will be identified and voted down by the majority executing the client's task. Thus the results of an alternate task's stripe will be annulled by the client's task as long as a majority of participating servers execute the client's task.

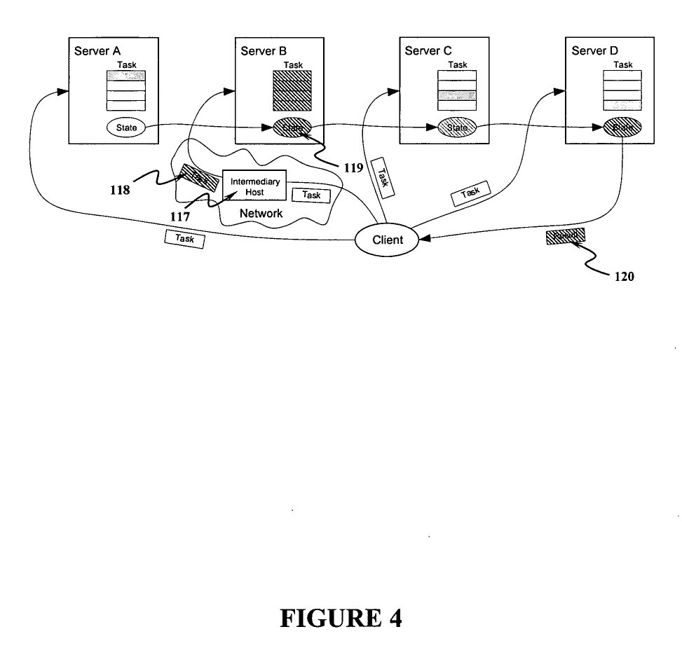

Still referring to FIG. 9, it is further depicted how the present invention annuls intermediary attacks, such as the one displayed in FIG. 4. Prior to the execution of stripe zero, server C 150 receives and loads a modified task 151. During the execution of stripe zero, servers A 152 and B 153 perform identical tasks while C 150 performs the modified task. At the end of the stripe, all of the servers 152, 153, 151 cast a vote by forwarding the state of their respective virtual machines 154 to the poller “P”. It is at this point that the modification of server C's task 151 is identified. The majority state (that of servers A and B) 155 is forwarded and loaded into all servers prior to the execution of stripe one. This causes the state in server C 150 to be restored to the correct state 156. The servers perform a second round of stripe execution. Again, server C 150 produces the incorrect result 157 and servers B 153 and C 150 mask the erroneous result by voting it down. This process repeats, each time restoring the correct state by replacing the erroneous state. Finally, the last stripe's execution completes and the majority's state 158 is forwarded to the client. The effect is that the compromised task 151 in server C 150 is allowed to continue, but the redundancy in the system ensures that a majority of tasks must be modified in order to affect the client's result.

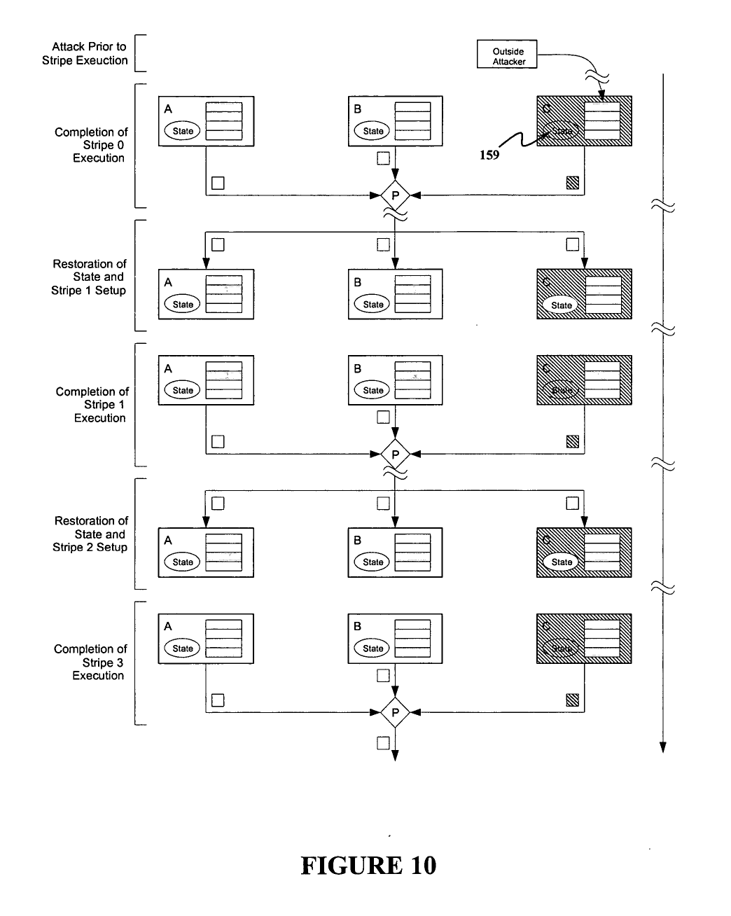

Referring to FIG. 10, in addition to intermediary attacks on client tasks, a compromised server can alter a client's task, or the execution of that task. Clients must be able to rely on servers to faithfully perform the client's requests. When a client's task is modified or incorrectly executed by the server, the result is the same as having an intermediary introduce an alternate task. The present invention annuls an attack on a task by a compromised server, such as the attack displayed in FIG. 6. Upon comparison by the poller (see FIG. 7, 135), the compromised server's stripe state 159 will be voted down by the majority. This, in effect, protects the client's task from attack by a compromised server.

Just as the client must trust the server to correctly execute the client's task, the server must trust the client task not to attack the server. The task striping mechanism can also protect the server from attacks from client code. In this situation, an intermediary may alter a client's task as described previously, or it may introduce a new client task for an individual server to execute. Here, the goal of the intermediary is to compromise the server. The invention protects the server by imposing a bound, S, on the stripe size (typically a constant). For any successful server attack, there is a lower bound, M, on the number of server machine instructions in the attack's task. Since each server's virtual machine state is refreshed between stripe executions, no minority's state is preserved from one stripe to the next. Thus, a successful attack must be placed within a single stripe. This places an upper bound on the size of a successful attack of S machine instructions. Therefore, a stripe of size S will successfully thwart all attacks of size greater than S . Consequently, as S is decreased, the level of protection is increased.

While the preferred embodiments have been described and illustrated, it should be understood that various substitutions, equivalents, adaptations and modifications of the invention may be made thereto by those skilled in the art without departing from the spirit and scope of the invention. Accordingly, it is to be understood that the present invention has been described by way of illustration and not limitation.

The invention is claimed as follows:

1. Method for protecting servers and tasks in a distributed system, comprising the steps: of:
controlling the execution of remote tasks at each server by a stripe virtual machine process wherein said stripe virtual machine process further comprises the steps of
executing stripes within a stripe execution environment; and
managing stripe states.

2. Method of claim 1, wherein said step of executing stripes within a stripe execution environment further comprises the steps of
starting said servers;
stopping said servers;
resuming execution of said tasks; and
translating between application code and machine code.

3. Method of claim 1, wherein said step of managing stripe states further comprises the steps of
enabling said server to capture the current memory state of a stopped task;
transmitting said captured task to other servers through a network adapter; and
receiving task state updates from other servers.

4. Method of claims 2 and 3, further comprising the steps of
executing stripes redundantly on multiple servers; and
executing stripes concurrently on each server.

5. Method of claim 4, wherein said step of executing stripes redundantly on multiple servers comprises the steps of
transmitting each task from client to each server;
loading each task onto each server;
executing stripe in each server;
capturing the virtual machine state in each server;
transmitting said virtual machine state from each server to poller;
comparing and tallying results in poller;
determining whether said task is COMPLETED, wherein
IF said task is COMPLETED, then transmitting final result from poller to client,
OTHERWISE, if it is determined that said task is NOT
COMPLETED, then
transmitting majority state from said poller to said servers;
loading new majority virtual machine state into said servers;
and
returning to said step of executing stripe in each server.

6. Method of claim 4 wherein said step of executing stripes concurrently on each server comprises the steps of
loading a task onto a server;
determining whether stripe is COMPLETED, wherein
IF said stripe is COMPLETED, then
capturing virtual machine state;
transmitting said virtual machine state to poller;
determining whether said task is COMPLETED, wherein
IF said task is COMPLETED, then stopping said step of executing stripes concurrently;
OTHERWISE, if it is determined that said task is NOT COMPLETED, then
loading new majority virtual machine state;
determining whether a new stripe is to be executed,
wherein
F it is determining that a new stripe is to be executed, then
returning to said step of loading a task onto a server;
OTHERWISE, returning to said step of loading new majority virtual machine state;
OTHERWISE, if it is determined that said stripe is NOT COMPLETED, then
fetching and executing instruction;
loading next server; and
returning to said step of determining whether stripe is COMPLETED.

7. Method for annulling an intermediary attack in a distributed system, comprising the steps of
forwarding the virtual machine state of each of a plurality of servers to a poller;
determining a majority state among said plurality of servers;
identifying an incorrect modified task in one of said servers, said task having been modified as a result of said intermediary attack;
loading the majority state into all servers prior to the execution of the first stripe;
restoring to the correct majority state, the state of said server which contains said incorrect modified task; and
repeating said steps of forwarding, determining, identifying, loading and restoring for each round of stripe execution.

8. Method for annulling the affect of a compromised server on a task in a distributed system, comprising the steps of
comparing the stripe state of each of a plurality of servers in a poller;
determining a majority state among said plurality of servers; and
voting down said compromised server's state by said majority state.

9. Method of claims 1 though 8, further comprising the steps of
imposing an upper bound on said stripe size as measured in the number of server machine instructions contained therein;
refreshing said virtual machine state of each of said plurality of servers between said stripe executions so as to erase any minority state prior to a successive stripe execution; and
rejecting all server tasks in which stripe size thereof exceeds said upper bound.

10. Method of claim 9 wherein decreasing said upper bound on said stripe size as measured in the number of server machine instructions contained therein increases the level of protection afforded to said distributed system.

11. Apparatus for protecting servers and tasks in a distributed system, comprising:
means for controlling the execution of remote tasks at each server by a stripe virtual machine process wherein said stripe virtual machine process further comprises
means for executing stripes within a stripe execution environment; and
means for managing stripe states.

12. Apparatus of claim 11, wherein said means for executing stripes within a stripe execution environment further comprises
means for starting said servers;
means for stopping said servers;
means for resuming execution of said tasks; and
means for translating between application code and machine code.

13. Apparatus of claim 11, wherein said means for managing stripe states further comprises
means for enabling said server to capture the current memory state of a stopped task;
means for transmitting said captured task to other servers through a network adapter; and
means for receiving task state updates from other servers.

14. Apparatus of claims 12 and 13, further comprising
means for executing stripes redundantly on multiple servers; and
means for executing stripes concurrently on each server.

15. Apparatus of claim 14, wherein said means for executing stripes redundantly on multiple servers comprises
means for transmitting each task from client to each server;
means for loading each task onto each server;
means for executing stripe in each server;
means for capturing the virtual machine state in each server;
means for transmitting said virtual machine state from each server to poller;
means for comparing and tallying results in poller;
means for determining whether said task is COMPLETED, wherein
IF said task is COMPLETED, then further comprising means for transmitting final result from poller to client,
OTHERWISE, if it is determined that said task is NOT
COMPLETED, then further comprising
means for transmitting majority state from said poller to said servers;
means for loading new majority virtual machine state into said servers; and
means for returning to said step of executing stripe in each server.

16. Apparatus of claim 14 wherein said means for executing stripes concurrently on each server comprises
means for loading a task onto a server;
means for determining whether stripe is COMPLETED, wherein
IF said stripe is COMPLETED, then further comprising
means for capturing virtual machine state;
means for transmitting said virtual machine state to poller;
means for determining whether said task is COMPLETED, wherein
IF said task is COMPLETED, then further comprising
means for stopping said step of executing stripes concurrently;
OTHERWISE, if it is determined that said task is NOT
COMPLETED, then further comprising
means for loading new majority virtual machine state;
means for determining whether a new stripe is to be executed, wherein
IF it is determined that a stripe is to be executed, then further comprising
means for returning to said step of loading a task onto a server;
OTHERWISE, means for returning to said step of loading new majority virtual machine state;
OTHERWISE, if it is determined that said stripe is NOT COMPLETED, then further comprising
means for fetching and executing instruction;
means for loading next server; and
means for returning to said step of determining whether stripe is COMPLETED.

17. Apparatus for annulling an intermediary attack in a distributed system, comprising
means for forwarding the virtual machine state of each of a plurality of servers to a poller;
means for determining a majority state among said plurality of servers;
means for identifying an incorrect modified task in one of said servers, said task having been modified as a result of said intermediary attack;
means for loading the majority state into all servers prior to the execution of the first stripe;
means for restoring to the correct majority state, the state of said server which contains said incorrect modified task; and
means for repeating said forwarding, determining, identifying, loading and restoring for each round of stripe execution.

18. Apparatus for annulling the affect of a compromised server on a task in a distributed system, comprising
means for comparing the stripe state of each of a plurality of servers in a poller;
means for determining a majority state among said plurality of servers; and
means for voting down said compromised server's state by said majority state.

19. Apparatus of claims 11 though 18, further comprising
means for imposing an upper bound on said stripe size as measured in the number of server machine instructions contained therein;
means for refreshing said virtual machine state of each of said plurality of servers between said stripe executions so as to erase any minority state prior to a successive stripe execution; and
means for rejecting all server tasks in which stripe size thereof exceeds said upper bound.

20. Apparatus of claim 19 wherein decreasing said upper bound on said stripe size as measured in the number of server machine instructions contained therein increases the level of protection afforded to said distributed system.

21. An apparatus as claims 11 through 20 being capable of carrying out computer implement-able instructions.
